(19) United States
(12) Patent Application Publication
(10) Pub. No.: US 2003/0197070 A1
(43) Pub. Date: Oct. 23, 2003

(54) Oil aerosol

(76) Inventor: Rick Lin, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/123,413

(22) Filed: Apr. 17, 2002

(51) Int. Cl. B05B 9/04

(52) U.S. Cl. 239/373

(57) ABSTRACT

An oil aerosol includes a depressing member, which consists of both an elongated part and an upper covering part. An air-compressing member has a movable member, which is moved up and down by means of the depressing member to make air flow into the aerosol. The depressing member can be locked with the top of the oil aerosol so that the upper covering part is disposed above the spray nozzle to prevent the same from being accidentally pressed when the oil aerosol is not used. The oil aerosol is provided with an escape valve for allowing the compressed air therein to be discharged when the same is not used.

### BACKGROUND OF THE INVENTION

The present invention relates to an oil aerosol, more particularly an oil aerosol, which is provided with a cover capable of being secured to the top to protect the spray nozzle when the oil aerosol is not used, and which is provided with an escape valve so that the high-pressure compressed air received therein is allowed to escape when it is not used.

In order to make food more delicious and pleasant to look at, seasonings and edible oils are spread on the food. Two conventional ways to do this is using a brush and using aerosol that contains certain chemicals capable of increasing pressure therein.

However, the bristles of brushes can easily fall off to dirt the food. And, the chemicals in conventional can react with the oil, and pollute the environment.

To overcome the above disadvantages, the inventor of the present invention had disclosed an oil aerosol, referring to FIG. 9, which includes a can member 41, a depressing member 42, a top cover 43, and a compressing member consisting of both a holding tube 44 and a movable cap 442.

The can member 41 is connected to the top cover 43, which has a nozzle 431 having a pipe disposed in a containing room of the can member 41.

The holding tube 44 is disposed in the holding room, and is joined to a through hole 432 of the top cover 43 at an upper end; the cap 442 is movably disposed in the holding tube 44; the cap 442 is biased up by an elastic member 441 so as to be capable of being moved up and down to force air to flow via holes of a lower end of the tube 44 into the containing room of the can member 41, thus allowing oil contained in the can member 41 to be discharged via the nozzle 431 by means of compressed air in the can member 41 when the nozzle 431 is operated.

The depressing member 42 includes an elongated pressing part 421 for pressing the cap 442 down along the holding tube 44; an upper confining ring 45 is fixedly disposed in the through hole 432 of the top cover 43 to prevent the cap 442 from falling off. The depressing member 42 is disposed at a bottom of the can member 41 with the elongated part 421 being received in a separate holding room 411 of the

This oil aerosol allows air to be easily compressed in the can member so that oil can be discharged via the nozzle only by means of high-pressure air without use of chemicals. However, when the oil aerosol is not used, oil can be accidentally discharged if the nozzle is touched. To avoid this, an additional cover has to be provided on the top of the top cover 43 for protecting the nozzle, resulting in increase of the manufacturing cost.

### SUMMARY OF THE INVENTION

Therefore, it is a main object of the present invention to provide an oil aerosol, which is equipped with a depressing member capable of being secured to the top thereof to protect the spray nozzle when the oil aerosol is not used; more specifically, the depressing member includes both a covering portion and an elongated pressing part connected to a lower side of the covering portion so that the covering portion can be disposed above the nozzle when it is locked with the can member with the elongated pressing part being received in a tube portion of a compressing member of the oil aerosol.

And, it is another object of the present invention to provide the oil aerosol with an escape valve so that the high-pressure compressed air received therein is allowed to escape when it is not used.

### BRIEF DESCRIPTION OF THE DRAWINGS

The present invention will be better understood by reference to the accompanying drawings, wherein:

FIG. 1 is an exploded perspective view of the oil aerosol of the present invention.

FIG. 2 is a cross-sectional view of the oil aerosol of the present invention under air compressing operation.

FIG. 3 is another cross-sectional view of the oil aerosol of the present invention under air compressing operation.

FIG. 4 is a top view of the oil aerosol of the present invention.

FIG. 5 is a cross-sectional view of the oil aerosol of the present invention with the depressing member being locked at the top.

FIG. 6 is a top view of the oil aerosol of the present invention with the depressing member being locked at the top.

FIG. 7 is another top view of the oil aerosol of the present invention with the depressing member being locked at the top.

FIG. 8 is another cross-sectional view of the oil aerosol of the present invention with the depressing member being locked at the top.

FIG. 9 is a cross-sectional view of the prior oil aerosol as described in the Background.

### DETAILED DESCRIPTION OF THE PREFERRED EMBODIMETS

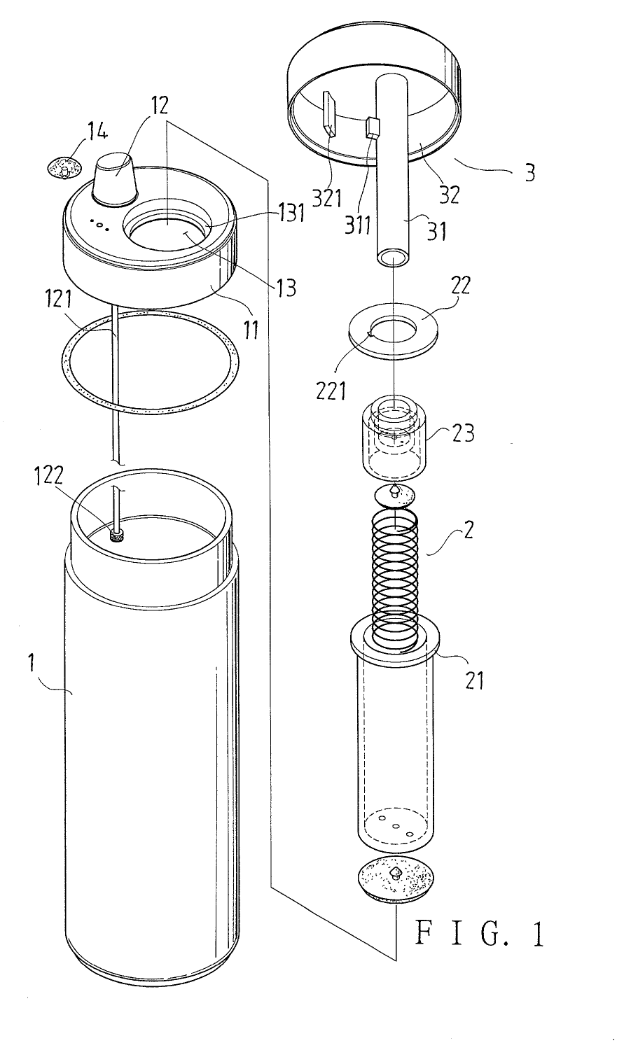

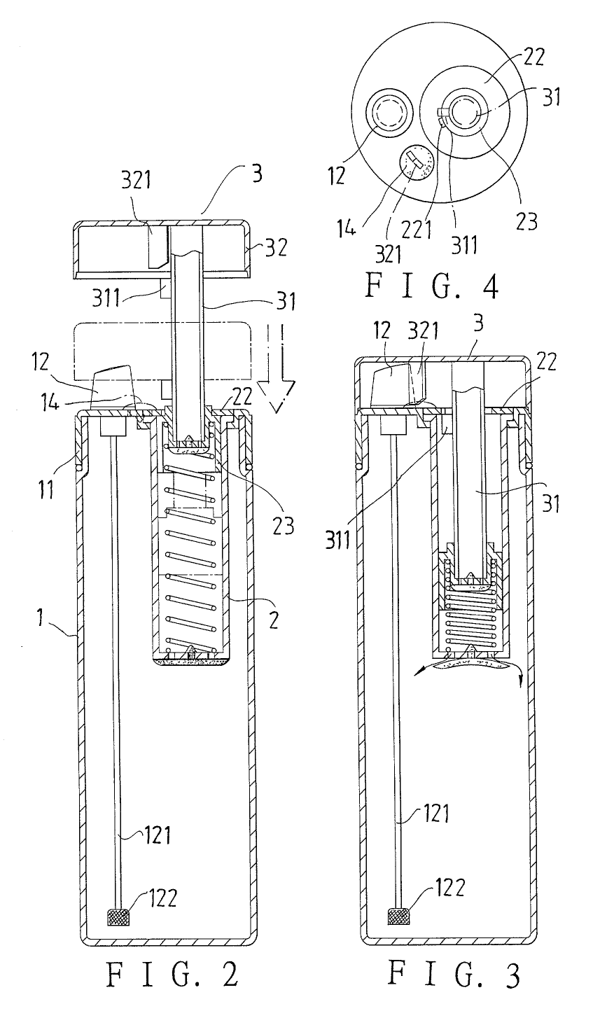

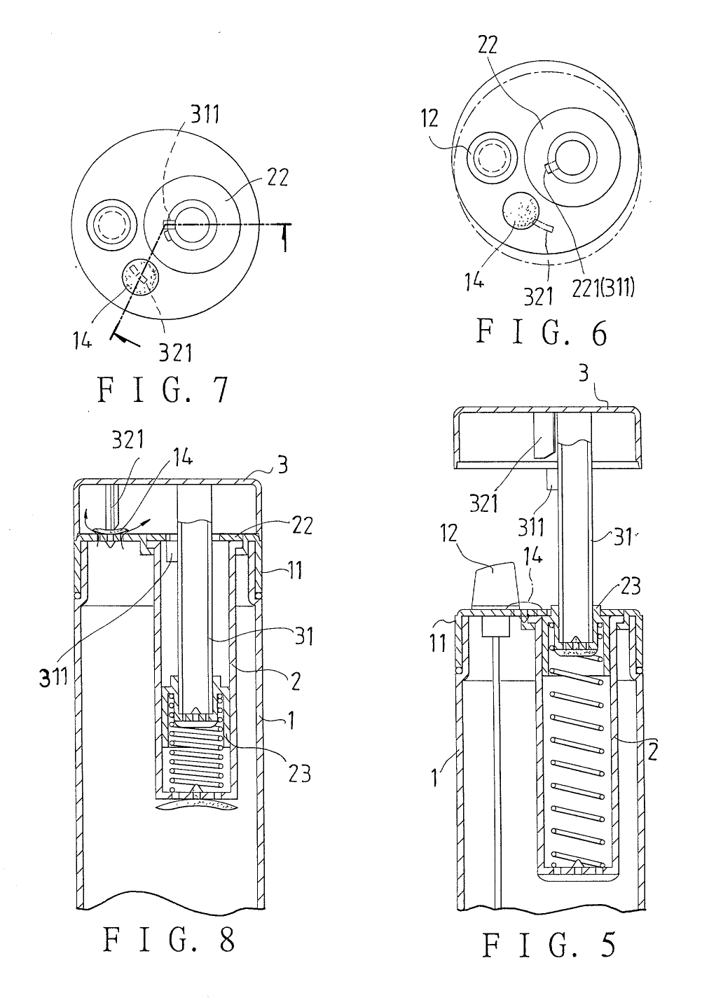

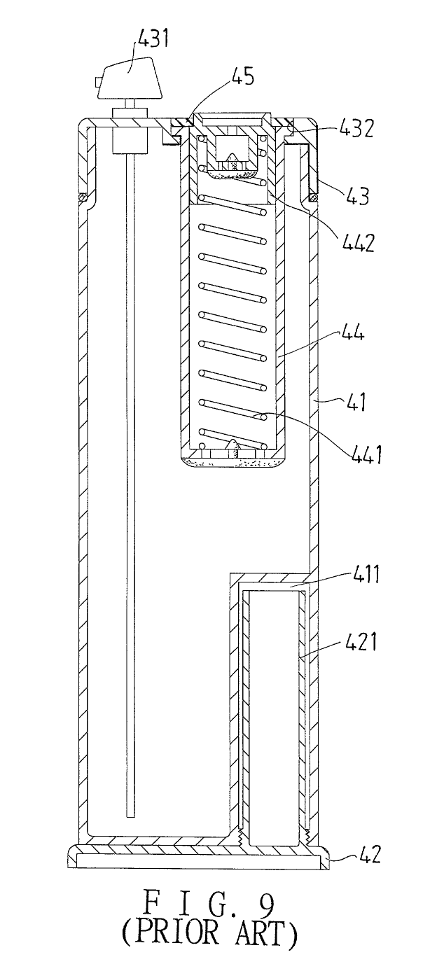

Referring to FIG. 1, an oil aerosol of the present invention includes a can member 1, a compressing member 2, and a depressing member 3. The can member 1 has an upper covering element 11, which is fitted to an upper end of the main holding body thereof. The upper covering element 11 has a spray nozzle 12 fitted thereto, and has a through hole 13; a pipe 121 of the nozzle 12 is disposed in the containing room of the can member. In addition, the pipe 121 is provided with a filtering net 122 at the lower end for filtering oil before the oil is discharged via the nozzle 12. The upper covering element 11 further has a supporting annular protrusion 132 on the edge of tile through hole 13 An escape valve 14 is disposed over vent holes (not numbered) of the upper covering element 11.

The compressing member 2 includes a holding tube, which is disposed in the holding body of the can member 1, and joined to the through hole 13 of the upper covering element 11 at an upper end. An annular protrusion 21 is formed at the upper end of the holding tube to be supported by the annular protrusion 131 of the upper covering element 11 The compressing member 2 has a cap 23 movably disposed in the holding tube; the cap 23 is biased up by an elastic member disposed in the holding tube so that it can be moved up and down to force air to flow via holes (not numbered) of a lower end of the tube into the containing room of the can member 1, thus allowing oil contained in the can member 1 to be discharged via the nozzle 12 by means of compressed air received in the can member 1 when the nozzle 12 is operated. In addition, an upper confining ring 22 is fixedly disposed above the annular protrusion 21 to prevent the cap 23 from falling off. An engaging hole 221 is formed at an inner edge of the upper confining ring 22.

The depressing member 3 includes both a covering portion 32, and an elongated pressing part 31, which is connected to a lower side of the covering portion 32. The depressing member 3 is provided for the user to press the cap 23 down along the holding tube by means of passing the elongated part 31 through the ring 22. An engaging protrusion 311 is formed on a lateral side of the elongated pressing part 31, while a pressing protrusion 321 is provided on the lower side of the covering portion 32; the covering portion 32 of the depressing member 3 can be locked above the upper covering element 11 by means of passing the engaging protrusion 311 through the engaging hole 221 plus turning the covering portion 32 so as to make the engaging protrusion 311 retained by a bottom of the confining ring 22; the pressing protrusion 321 can come into contact with the escape valve 14 to open the same when the covering portion 32 is locked above the top covering element 11 at a position as shown in FIG. 6, thus allowing compressed air in the can member 1 to be discharged for reducing the air pressure in the can member 1 if need be.

From the above description, it can be easily understood that the oil aerosol of the present invention has advantages as followings:

1. Besides being used to depress the cap 23 for discharging oil, the depressing member 3 can cover the upper covering part of the can member to prevent the nozzle from being accidentally pressed; no additional cover has to be manufactured that will increase the cost.

2. The escape valve allows the high-pressure compressed air to escape out of the can member when the oil aerosol is not used, thus eliminating the risk of the can exploding.

What is claimed is:

1. An oil aerosol, comprising
a can member, the can member having a top covering element fitted to an upper end, the top covering element having a spray nozzle having a pipe disposed in a containing room of the can member;
a compressing member, the compressing member having a holding tube disposed in the holding room and joined to a through hole of the top covering element at an upper end of the holding tube, the compressing member having a cap movably disposed in the holding tube, the cap being biased up by an elastic member so as to be capable of being moved up and down to force air to flow via holes of a lower end of the tube into the containing room of the can member, thus allowing oil contained in the can member to be discharged via the nozzle by means of compressed air in the can member when the nozzle is operated;
a depressing member, the depressing member including both a covering portion and an elongated pressing part connected to a lower side of the covering portion for pressing the cap down along the holding tube; an upper confining ring being fixedly disposed in the through hole of the top covering element to prevent the cap from falling off,
the oil aerosol being characterized by an engaging protrusion formed on a lateral side of the elongated pressing part as well as an engaging hole formed at an inner edge of the upper confining ring for allowing the covering portion of the depressing member to be locked above the top covering element by means of making the engaging protrusion pass through the engaging hole plus retained by a bottom of the confining ring.

2. The oil aerosol of claim 1, wherein the top covering element is provided with an escape valve for allowing the compressed air in the can member to be discharged.

3. The aerosol of claim 2, wherein the covering portion of the depressing member is provided with a pressing protrusion on a lower side, the pressing protrusion being capable of coining into contact with the escape valve to open the same when the covering portion is locked above the top covering element.

4. The oil aerosol of claim 1, wherein the pipe of the spray nozzle is provided with a filtering net on a lower end thereof.
